(19) United States
(12) Patent Application Publication
(10) Pub. No.: US 2017/0078351 A1
(43) Pub. Date: Mar. 16, 2017

(54) CAPTURE AND SHARING OF VIDEO

(71) Applicant: LYVE MINDS, INC., Cupertino, CA (US)

(72) Inventors: Andreas von Sneidern, San Jose, CA (US); Jeff Fisher, Cupertino, CA (US)

(21) Appl. No.: 14/855,225

(22) Filed: Sep. 15, 2015

(51) Int. Cl. H04L 29/06; H04L 29/08; H04N 5/232

(52) U.S. Cl. CPC H04L 65/602; H04N 5/23245; H04L 65/608; H04L 67/02

(57) ABSTRACT

According to some embodiments, the present disclosure may relate to a device for capturing video comprising a camera configured to record a plurality of images in succession such that the plurality of images displayed in succession creates an appearance of motion. The device may also include a wireless communication component configured to transmit one or more of the plurality of images to a server and one or more processors configured to execute instructions. The device may further include a computer-readable media containing executable instructions that when executed by the one or more processors are configured to cause the device to select a consecutive subset of the plurality of images as a block of images and transmit the block of images to the server. The present disclosure may also related to associated systems and methods.

### FIELD

The embodiments discussed herein are related to the capture and sharing of video.

### BACKGROUND

With the prevalence of cameras and the inclusion of cameras on cellular telephones, the capturing of images and even videos has become ubiquitous. As technology has evolved, the size of images has increased to provide for higher quality images and videos. However, with that increased size has come difficulties in sharing such images and videos. The present disclosure provides potential solutions to at least some of those difficulties.

The subject matter claimed herein is not limited to embodiments that solve any disadvantages or that operate only in environments such as those described above. Rather, this background is only provided to illustrate one example technology area where some embodiments described herein may be practiced.

### SUMMARY

One embodiment of the present disclosure includes a device for capturing video comprising a camera configured to record a plurality of images in succession such that the plurality of images displayed in succession creates an appearance of motion. The device may also include a wireless communication component configured to transmit one or more of the plurality of images to a server and one or more processors configured to execute instructions. The device may further include a computer-readable media containing executable instructions that when executed by the one or more processors are configured to cause the device to select a consecutive subset of the plurality of images as a block of images and transmit the block of images to the server.

Another embodiment of the present disclosure includes a system including a server configured to stream video to a remote device and a device for capturing video. The device may include a camera configured to record a plurality of images in succession such that the plurality of images displayed in succession creates an appearance of motion and a wireless communication component configured to transmit one or more of the plurality of images to the server. The device may also include one or more processors configured to execute instructions and a computer-readable media containing executable instructions that when executed by the one or more processors are configured to cause the device to select a consecutive subset of the plurality of images as a block of images and transmit the block of images to the server such that the server can stream the block of images within about one minute.

An alternative embodiment of the present disclosure includes a method including recording a plurality of images by a device including a camera and selecting a consecutive subset of the plurality of images as a block of images. The method may further include transmitting the block of images to a server and making accessible the block of images for streaming from the server within about one minute.

The object and advantages of the embodiments will be realized and achieved at least by the elements, features, and combinations particularly pointed out in the claims.

Both the foregoing general description and the following detailed description provide examples and are explanatory and are not restrictive.

### BRIEF DESCRIPTION OF THE DRAWINGS

Example embodiments will be described and explained with additional specificity and detail through the use of the accompanying drawings in which:

FIG. 1 is a diagram representing an example device for capturing and sharing video, in accordance with some embodiments of the present disclosure;

FIG. 2 illustrates an example system for capturing and sharing video, in accordance with some embodiments of the present disclosure;

FIG. 3 is an alternative example embodiment of a visual depiction of a device for capturing and sharing video, in accordance with some embodiments of the present disclosure; and

FIG. 4 is a flowchart of an example method of capturing and sharing video, in accordance with some embodiments of the present disclosure.

### DESCRIPTION OF EMBODIMENTS

Some embodiments described herein relate to the capture and sharing of video using a camera or other electronic device. For example, the camera may capture video and may nearly instantaneously send that video to a server to be available for streaming from the server. Often such streaming is for pre-packaged and prepared content, rather than a situation in which video recorded by a camera is almost immediately available to stream. The present disclosure also contemplates simultaneously capturing multiple resolutions of video and intelligently selecting which of those resolutions may be made available first. At least some of the embodiments of the present disclosure solve technical problems specifically associated with cameras and, more specifically, transmitting data to or from cameras which may have limited computing power in the camera.

Embodiments of the present disclosure are explained with reference to the accompanying drawings.

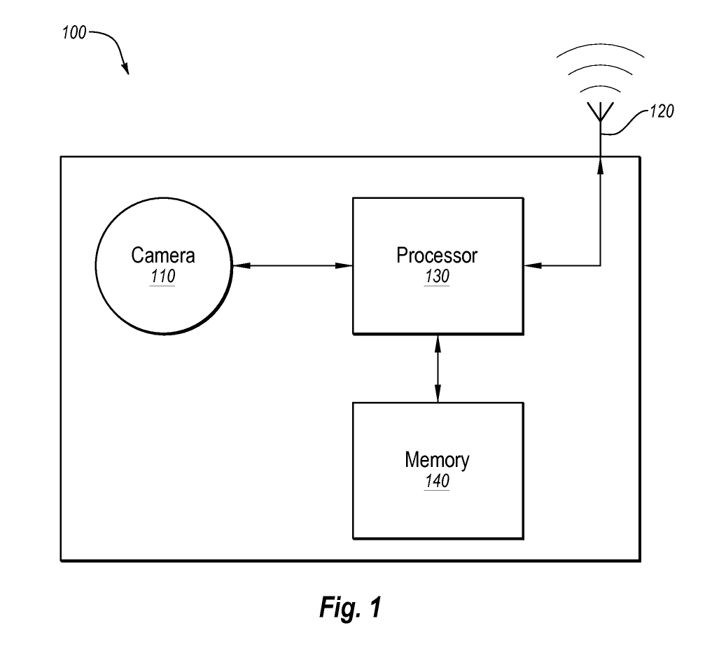

FIG. 1 is a diagram representing an example device for capturing and sharing video, in accordance with some embodiments of the present disclosure. A device 100 may be any device, system, component or collection of components suitable for capturing and sharing video in the manner described in the present disclosure. For example, the device 100 may be embodied as a stand-alone camera, as a cellular telephone with the ability to capture images, as a tablet or computer with a camera, as a multi-function electronic device such as a personal digital assistant (PDA) with image capturing capability, or the like. The device 100 may include a camera 110, a communication component 120, a processor 130, and a memory 140. In operation, the device 100 may capture a series of images in succession such that when displayed in succession, the appearance of motion may be perceived. Such a succession of images may be referred to as a video. The device 100 may utilize the camera 110 to capture the series of images. The device 100 may additionally utilize the communication component 120 to transmit one or more of the images to a remote location. The processor 130 may execute instructions stored on the memory 140 to control and/or direct the operation of the device 100.

The camera 110 of the device 100 may include optical elements such as, for example, lenses, filters, holograms, splitters, etc., and an image sensor upon which an image may be recorded. Such an image sensor may include any device that converts an image represented by incident light into an electronic signal. The image sensor may include a plurality of pixel elements, which may be arranged in a pixel array (e.g., a grid of pixel elements). For example, the image sensor may comprise a charge-coupled device (CCD) or complementary metal-oxide-semiconductor (CMOS) image sensor. Various other components may also be included in the camera 110. The pixel array may include a two-dimensional array with an aspect ratio of 1:1, 4:3, 5:4, 3:2, 16:9, 10:7, 6:5, 9:4, 17:6, etc., or any other ratio. The image sensor may be optically aligned with various optical elements that focus light onto the pixel array, for example, a lens. Any number of pixels may be included such as, for example, eight megapixels, fifteen megapixels, twenty megapixels, fifty megapixels, one hundred megapixels, two hundred megapixels, five hundred megapixels, one thousand megapixels, etc. In some embodiments, the images may be captured to produce video at any of a variety of resolutions, aspect ratios, and frame rates, including, for example, 720p video (e.g. 16:9 aspect ratio and 1280×720 pixels), 1080p video (e.g 16:9 aspect ratio and 1920×1080 pixels), or 4 k video (e.g. 16:9 aspect ratio and 4096×2160 pixels). The camera 110 may collect images and/or video data. In some embodiments, the camera 110 may capture a plurality of resolutions of an image.

In some embodiments, the camera 110 may capture an entire video as a series of consecutive subsets of images referred to as a block of images. In this way, each block of images may be treated uniquely for compression, image processing, etc. For example, each block of images may have a different number of resolutions captured for it, and each block of images may be transmitted at a different resolution, and each block of images may have unique image processing performed. The size and number of blocks may be determined prior to recording of the video or may be a dynamic determination made while the video images are being captured. In some embodiments the block size may be the size of the video, or in other words the entire video may be a single block of images.

The communication component 120 may be any component, device, or combination thereof configured to transmit one or more images to a remote location. The communication component 120 may include, without limitation, a modem, a network card (wireless or wired), an infrared communication device, a wireless communication device (such as an antenna), and/or chipset (such as a Bluetooth device, an 802.6 device (e.g. Metropolitan Area Network (MAN)), a WiFi device, a WiMax device, cellular communication facilities, etc.), and/or the like. The communications component 120 may permit data to be exchanged with a network (such as a cellular network, a WiFi network, a MAN, etc., to name a few examples) and/or any other devices described herein, including remote devices. In some embodiments the communication component 120 may be operable to communicate using one or more of a variety of media streaming transmission protocols, including but not limited to Hypertext Transfer Protocol (HTTP) Live Streaming (HLS), Real Time Transport Protocol (RTP), Real Time Streaming Protocol (RTSP), Real Time Messaging Protocol (RTMP), HTTP Dynamic Streaming (HDS), Smooth Streaming, Dynamic Streaming over HTTP (DASH), etc.

The processor 130 may include any suitable special-purpose or general-purpose computer, computing entity, or processing device including various computer hardware or software modules and may be configured to execute instructions stored on any applicable computer-readable storage media. For example, the processor 130 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 1, the processor 130 may include any number of processors configured to perform, individually or collectively, any number of operations described in the present disclosure. Additionally, one or more of the processors may be present on one or more different electronic devices, such as different devices coupled together or communicating remotely. By way of example, this may include a camera or cellular telephone docked with a docking electronic device, each of which may perform some of the operations described in the present disclosure.

In some embodiments, the processor 130 may interpret and/or execute program instructions and/or process data stored in the memory 140. In some embodiments, the processor 130 may fetch program instructions from a data storage and load the program instructions in the memory 140. After the program instructions are loaded into memory 140, the processor 130 may execute the program instructions. In some embodiments, the execution of instructions by the processor 130 may direct and/or control the operation of the device 100. For example, the processor 130 may instruct the camera 110 to capture images at a certain resolution (or multiple resolutions) and at a certain number of images per second.

The memory 140 may include computer-readable storage media for carrying or having computer-executable instructions or data structures stored thereon, including one or more of the images captured by the camera 110. Such computer-readable storage media may include any available media that may be accessed by a general-purpose or special-purpose computer, such as the processor 130. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 130 to perform a certain operation or group of operations. In some embodiments, memory 140, while depicted as a single component, may be multiple components. For example, memory 140 may be implemented as a combination of RAM, ROM, and flash memory.

The memory 140 may also store one or more of the images captured by the camera 110. By way of example, the processor 130 may instruct the camera 110 to capture an image and may direct the memory 140 to store the image. In some embodiments, the processor 130 may instruct the memory to store the same image in multiple resolutions. For example, the processor 130 may simultaneously send an image with every possible pixel used in generating a maximum resolution image while also sending an image with one in every four pixels (or the average of the four pixels as a single pixel) used in generating a lower resolution image. This example is non-limiting, and any number of resolutions and variations between resolutions may be used. Additionally, other techniques and methods for simultaneously capturing multiple resolutions from a single camera as known in the art are expressly contemplated. For example, a maximum resolution image may be suitable for 4 k video, and simultaneously images for 720p and 480p video may also be captured and stored.

While the term “simultaneously” is used, it will be appreciated that in different embodiments the term contemplates both literally at the same time as well as contemplating the concept of within rapid succession. For example, in embodiments in which multiple processors or multiple cores of processors may be operating it may be the case that multiple resolutions of images are literally captured and stored at the same time. In contrast, in some embodiments with a single processor it may be successive or nearly successive processing threads which may “simultaneously” capture and/or send multiple resolutions of images for storage. By way of non-limiting examples, in such an embodiment, the multiple resolutions may be captured within one tenth of a second of each other, within one half of a second of each other, within one second of each other, etc.

Modifications, additions, or omissions may be made to the device 100 without departing from the scope of the present disclosure. For example, in some embodiments, the device 100 may include any number of other components that may not be explicitly illustrated or described.

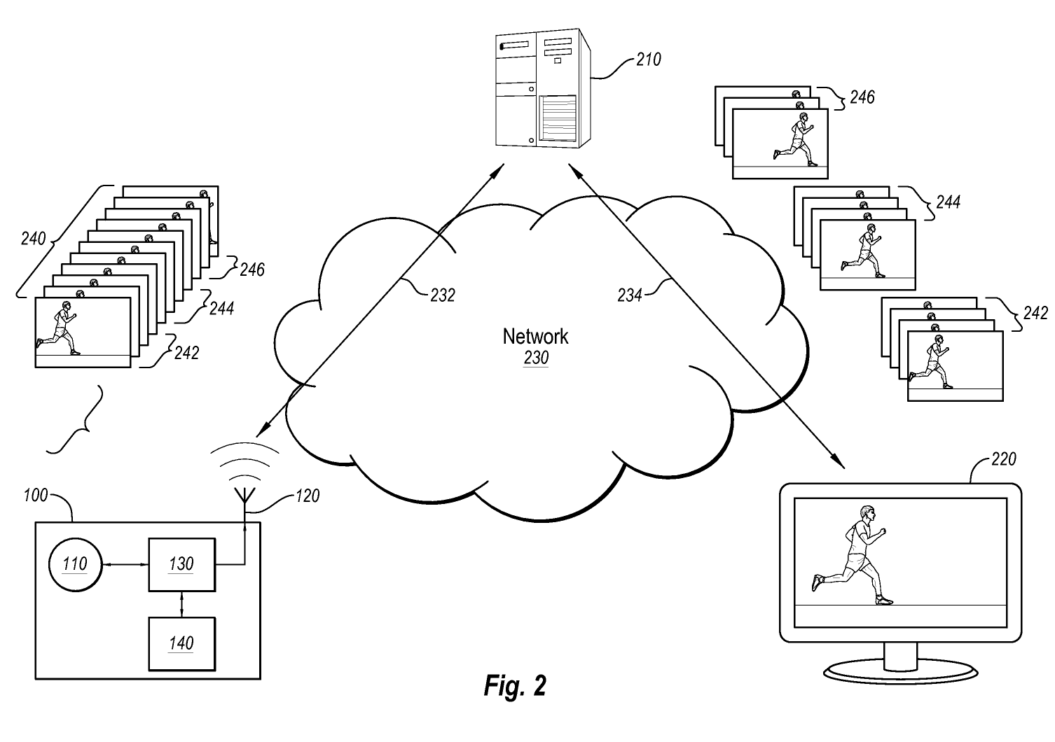

FIG. 2 illustrates an example system 200 for capturing and sharing a video 240, in accordance with some embodiments of the present disclosure. The system 200 may include the device 100, a server 210, and a remote device 220. The device 100 may be in communication with the server 210 over a network 230 over communication channel 232 and the server 210 may be in communication with the remote device 220 over the network 230 over communication channel 234. For example, the device 100 may transmit a series of blocks of images, blocks 242, 244, and 246, making up the video 240, to the server 210. The server 210 may stream the blocks 242, 244, and 246 to the remote device 220.

The server 210 may be any computing system operable to store one or more images received from the device 100 and make those images available to the remote device 220, for example, to be streamed to remote device 220. The server 210 may include a processor, a memory, and a data storage. The processor, the memory, and the data storage may be communicatively coupled. The processor may be implemented in a similar manner as described for the processor 130, and the memory and the data storage may be implemented in a similar manner as described for the memory 140.

In some embodiments, the server 210 may work cooperatively with the device 100 to make the video 240 captured by the device 100 available for streaming almost immediately. For example, the device 100 may capture the video 240 as described in the present disclosure, and may then transmit the blocks 242, 244, and 246 making up the video 240 to the server 210. The server 210 may then make the blocks 242, 244, and 246 available to be streamed as a video. The time between the device 100 capturing the video 240 and the server 210 making the blocks 242, 244, and 246 available to be streamed may be very short. This may be approximately within ten seconds, thirty seconds, one minute, five minutes, or ten minutes, etc. This may also be within certain ranges, for example, between ten seconds and thirty seconds, between fifteen seconds and forty five seconds, between fifteen seconds and one minute, between thirty seconds and one minute, between thirty seconds and five minutes, between one minute and ten minutes, etc. The time difference between capturing the video and the video being available for streaming may depend on a variety of factors, including whether image processing and/or compression is performed at the device 100 or the server 210, the communication speed over the communication channel 232, the capabilities of device 100 (for example processor speeds), the resolution of the video 240, length of the video 240, bit rate (quality) of video (which may vary independently of resolution), battery level, power source, etc. The block 242 may be the first block recorded and may be transmitted and available for streaming prior to the completion of the recording of the video 240. For example, the block 242 may be transmitted to the server 210 and available for streaming while block 244 is being recorded and available for streaming before block 246 has started recording.

In some embodiments, the device 100 may wait to transmit the video 240 to the server 210 until a certain factor affecting the time difference between capturing and availability for streaming has been met. For example, the device 100 may wait until a Wi-Fi connection has been established, or until a certain network communication speed is guaranteed or experienced, etc.

In some embodiments, the blocks of images 242, 244, and 246 captured by the device 100 may be compressed or receive other image processing at one or more of the device 100 and the server 210. This may include compressing one or more of the images using a compression technique compatible with streaming, for example, using H.264 (also referred to as Moving Picture Experts Group-4 Part 10, Advanced Video Coding (MPEG-4 AVC)), high efficiency video coding (HEVC), etc. Other image processing may also occur, including color correction, brightening or darkening, sharpening, anti-aliasing, rotating, cropping, red-eye reduction, image stabilization, distortion correction, face detection, face recognition, object recognition, smile detection, etc. Other processing may also be performed such as selecting a subset of the images making up the video to be a shorter video available more quickly. This may include a time-lapse video, a synopsis video, or a highlight video.

A synopsis video may be a video that includes more than one video clip selected from portions of one or more original video(s) and joined together to form a single video. A synopsis video may also be created based on the relevance of metadata associated with the original videos. The relevance may indicate, for example, the level of excitement occurring with the original video as represented by motion data, the location where the original video was recorded, the time or date the original video was recorded, the words used in the original video, the tone of voices within the original video, and/or the faces of individuals within the original video, among others.

A synopsis video may be automatically created from one or more original videos based on relevance scores associated with the video frames within the one or more original videos. For instance, the synopsis video may be created from video clips having video frames with the highest or high relevance scores. Each video frame of an original video or selected portions of an original video may be given a relevance score based on any type of data. This data may be metadata collected when the video was recorded or created from the video (or audio) during post processing. The video clips may then be organized into a synopsis video based on these relevance scores.

In working cooperatively together, in some embodiments the device 100 and/or the server 210 may perform a determination as to where the image compression, processing, etc. may be performed. For example, the device 100 may determine that the device 100 has limited processing power and that the communication channel 232 between the device 100 and the server 210 has high bandwidth and thus, in such a scenario, the device 100 may offload all of the compression, image processing, etc. to the server 210. Alternatively, if the device 100 has a high processing capability and the communication channel 232 has low bandwidth, the compression, image processing, etc. may be performed at the device 100. Between these two options are any number of scenarios where the device 100 may determine that certain or all of the compression, image processing, etc. may be performed at the device 100, the server 210, or a combination thereof. The server 210 may also be the device to perform such a determination and may communicate to the device 100 which compression, image processing, etc. tasks are to be performed locally at the device 100 and which will be performed at the server 210 after transmission of the images to the server 210. While processing power of the device 100 and the server 210 and bandwidth of the communication channel 232 are mentioned, it will be appreciated that any number of additional factors may also go into such a determination, including the type of network over which the communication channel 232 is communicating, the resolution of the video, the length of the video, the volume of the memory 140, the workload on the server 210, the number of other devices communicating with the server 210, battery level, power source of the device 100, etc.

The network 230 may include, either alone or in any suitable combination, the Internet, an Intranet, a local Wi-Fi network, a wireless Local Area Network (LAN), a mobile network (e.g., a 3G, 4G, and/or LTE network), a LAN, a Wide Area Network (WAN), a MAN, a Bluetooth connection, or any other suitable communication network. The communication channels 232 and 234 may be any path over the network 230 that provides communication between the device 100 and the server 210 and between the server 210 and the remote device 220, respectively. The communication channels 232 and 234 expressly contemplated traversing multiple types and formats of networks and/or media, although they need not do so.

The remote device 220 may be any electronic device capable of receiving one or more of the blocks of images 242, 244, and 246 making up the video 240 from the server 210 across the communication channel 234. In some embodiments the remote device 220 may stream the video 240 from the server 210, for example using HLS or some other streaming protocol. In some embodiments, the remote device 220 may display the video 240 as it is received.

In some embodiments, the device 100 may treat the blocks 242, 244, and 246 differently in the transmission to the server 210. For example, the device 100 may send the block 242 at one resolution and may then send the block 244 at a second resolution and the block 246 at yet a third resolution. Each of the blocks 242, 244, and 246 may also have different compression, image processing, etc. As described previously, multiple resolutions of the blocks 242, 244, and 246 may be transmitted simultaneously from the device 100 to the server 210. For example, three different resolutions of the block 242 may be sent simultaneously from the device 100 to the server 210. In like manner, the server 210 may stream the blocks 242, 244, and 246 differently, for example, sending the different blocks in different resolutions to the remote device 220.

Modifications, additions, or omissions may be made to the system 200 without departing from the scope of the present disclosure. For example, in some embodiments, the system 200 may include any number of other components that may not be explicitly illustrated or described. For example, there may be multiple remote devices streaming the video 240 from the server 210.

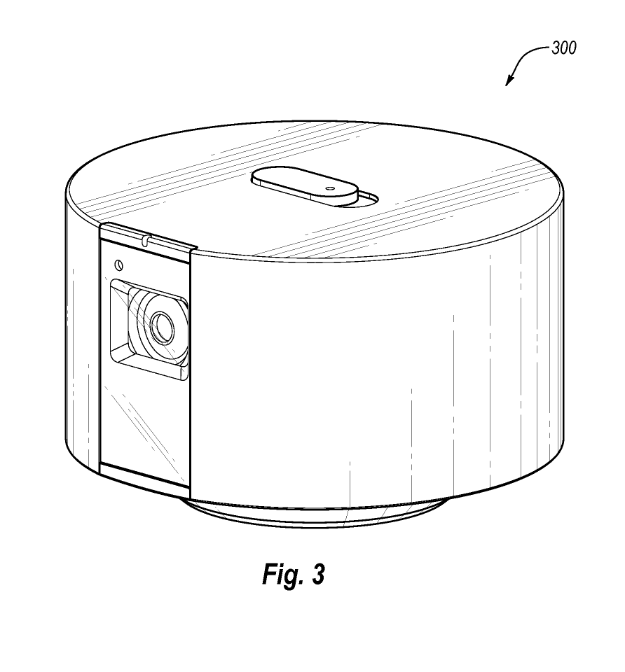

FIG. 3 is an alternative example embodiment of a visual depiction of a device for capturing and sharing video, in accordance with some embodiments of the present disclosure. The device 100 of FIG. 1 may be implemented as a dedicated camera 300. The dedicated camera 300 may be a device dedicated to the capture and sharing of images or videos. In some embodiments, the dedicated camera 300 may be equipped with motors to rotate or otherwise move the dedicated camera 300 while capturing images or video. While FIG. 3 provides one example of a visual depiction of the dedicated camera 300, it is merely provided for illustrative purposes and is in no way limiting.

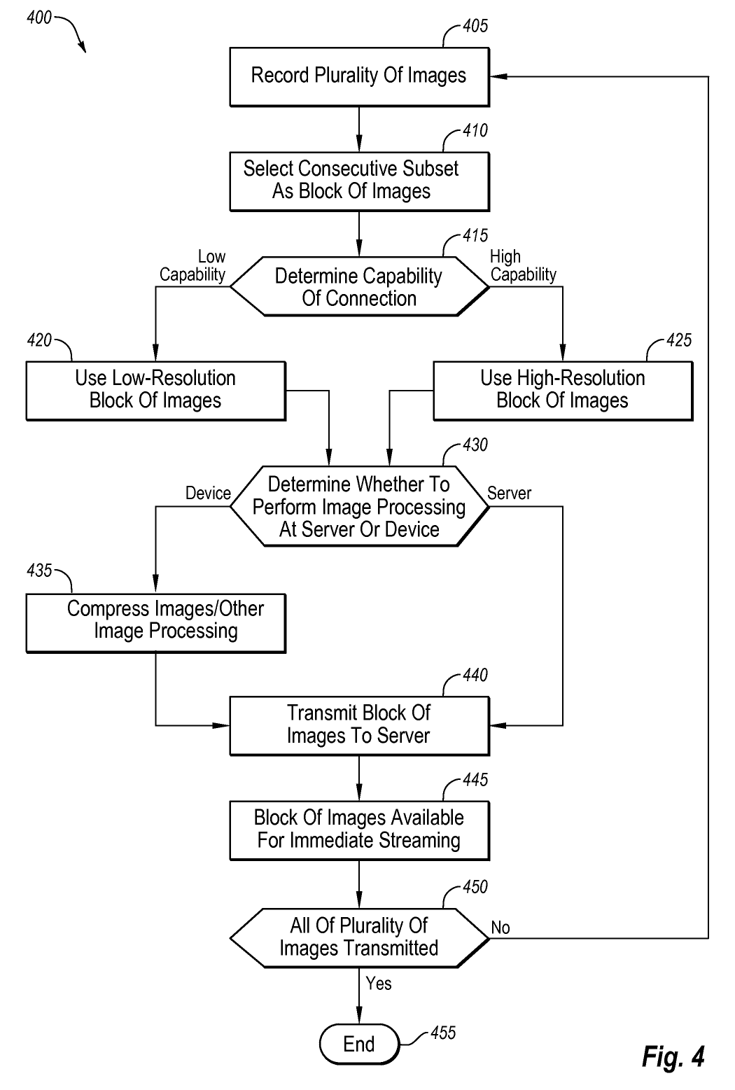

FIG. 4 is a flowchart of an example method 400 of capturing and sharing video, in accordance with some embodiments of the present disclosure. The method 400 may be performed by any suitable system, apparatus, or device. For example, the device 100 of FIG. 1, the system 200 of FIG. 2, or the dedicated camera 300 of FIG. 3 may perform one or more of the operations associated with the method 400. Although illustrated with discrete blocks, the steps and operations associated with one or more of the blocks of the method 400 may be divided into additional blocks, combined into fewer blocks, or eliminated, depending on the desired implementation.

At block 405 a camera associated with a device records a plurality of images. As described above, this may be a series of images that when displayed in rapid succession provides the appearance of motion, which may be referred to as video. When recording this plurality of images, the device may capture a plurality of resolutions of the images. For example, the device may capture images in resolution suitable for 4 k video as well as simultaneously capturing images in resolution suitable for 480p video. This capturing of multiple resolutions may occur using a single camera, for example a single CCD or CMOS sensor where the data captured by the sensor is stored in multiple resolutions simultaneously. As described above, this may occur by selecting a subset of the pixels, averaging a certain number of the pixels, or other techniques as known in the art. While block 405 is shown as recording a plurality of images, it will be appreciated that in capturing an entire video, the process may proceed to block 410 while the device continues to capture additional images as part of the same video already being processed.

At block 410 the device may select a consecutive subset of images as a block of images. As used herein to describe a “consecutive” subset of images, the term may refer to images that are captured immediately after one another or may be relatively close in proximity. For example, if a video were captured at a high frame rate, one in five frames for a span of time may be selected as one block of “consecutive” subset of images rather than selecting every single frame. In like manner, if a block of images for a time-lapse video derived from a more robust video were submitted, the video may be even further spread out, for example, one in every one hundred or three hundred or one thousand frames may be selected. Any number of frames may be skipped in this way. However, those frames would still be the “consecutive” frames within the block of images for the video being transmitted. For example, in omitting some of the frames the motion for a video may appear jerky, but the transmitted video would be smaller in total size because of the removal of the omitted frames.

At block 415, a determination may be made as to the capabilities of a connection between the device recording the plurality of images and a server. Such a connection between a device and a server may be implemented as described with reference to FIG. 2, for example, as a communication channel over a network. This determination may include consideration of any one or combination of the bandwidth of the connection, the type of connection (for example, a connection over a WiFi-based LAN versus a cellular network), the speed of the connection, etc. Based on one or more of these factors, the device may determine that the device has a low connection capability or a high connection capability. While a binary decision is depicted in FIG. 4 for convenience, it will be appreciated that any number of gradations and combinations of factors may lead to any number of classifications of the capabilities of the connection.

At block 420, when it is determined that the capability of the connection is low, the device may decide that a low resolution block of images of a plurality of resolutions will be processed and/or transmitted to the server. At block 425, when it is determined that the capability of the connection is high, the device may decide that a high resolution block of images of the plurality of resolutions will be processed and/or transmitted to the server. In addition to alternative resolutions, the determination may also lead to differences in frame rates (for example only selecting one of every five images as the consecutive images in the block of images), type of videos (for example a time-lapse video or a synopsis or highlight video), type and number of image processing tasks to be performed, etc.

At block 430, a determination may be made of whether to perform compression, image processing, etc. at the device locally or at the server. As described above, this may include consideration of factors including the processing capabilities of the device and/or the server, the load on the device and/or the server, the capabilities of the connection (including all the factors pertinent to that analysis), the length of the video, the resolution of the video, the power state of the device (for example, whether the device is operating on battery power or not and whether the battery is depleted below a certain threshold value or percentage), etc. While a binary decision as to the device vs. the server for the performance of compression, image processing, etc. is illustrated in FIG. 4, it will be appreciated that any combination of the device and the server may be selected for any, some, or all of the compression, image processing, etc. tasks. For example, it may be determined that the compression may be performed on the device locally and image processing including cropping and rotating may be performed at the server. In some embodiments, this determination is performed by the device and the device may instruct the server what tasks are to be performed, or alternatively, the device may perform the tasks the device determines the device should perform and may transmit the block of images to the server and allow the server to determine what tasks the server should perform. In other embodiments, this determination may be made by the server and the server may instruct the device what tasks to perform.

At block 435, any of the compression, image processing, etc. tasks determined to be performed by the device may be performed by the device. If no tasks are designated to the device, the process may proceed directly from block 430 to block 440. At block 440 the device may transmit the block of images to the server over the communication channel. This may be transmitted using any of a variety or combination of known transmission techniques, including streaming the video images to the server, for example, using HLS.

At block 445, the block of images may be made immediately available for streaming from the server to a remote device. In this way, a remote device may begin streaming an entire video (for example, the video made up of the plurality of images contemplated at block 405) because the block of images that is at the beginning of the video is already at the server and available for streaming, potentially even before the entire video has completed being recorded. Additionally, because each block of images has the potential to be handled differently, a remote device may receive different resolutions that may be optimized for the remote device. For example, in some embodiments the remote device may begin streaming a video and may have a limited connection to the server and so the server may process the video or instruct the device to process the video so that a lower resolution video is transmitted and made available for streaming in blocks of images later in the video.

At block 450 the device may determine whether all of the blocks of images of the plurality of images have been transmitted to the server. In other words, it may be determined whether the entire video has been transmitted. This may also include determining whether all of the desired resolutions and types of videos have been transmitted. For example, an entire synopsis video may have been transmitted but the entire video may not have been transmitted. If not all of the blocks of images at all the desired resolutions and/or types of videos have been transmitted, the process may return to block 405. This may allow the process to select a next consecutive subset of images as a next block of images to process. It will be appreciated that if the entire video has already been captured, the process may simply proceed to block 410 without recording any additional images. If all of the desired video has been transmitted, including resolutions and types of videos, the process may proceed to block 455 to end.

Accordingly, the method 400 may be used to capture and share video. Modifications, additions, or omissions may be made to the method 400 without departing from the scope of the present disclosure. For example, the operations of method 400 may be implemented in differing order. By way of example, blocks 410, 415, and 430 may have their order changed around in any combination. Additionally or alternatively, two or more operations may be performed at the same time. For example, the operation at the block 405 may continue while the process proceeds. As another example, any one or a combination of operations at the blocks 410, 415, 430, and 435 may be performed at the same time. Furthermore, the outlined operations and actions are only provided as examples, and some of the operations and actions may be optional, combined into fewer operations and actions, or expanded into additional operations and actions without detracting from the essence of the disclosed embodiments. For example, operations at the blocks 415, 420, 425, 430, 435, and 450 may be removed from the method 400. All of the examples provided above are non-limiting and merely serve to illustrate the flexibility and breadth of the present disclosure.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” the term “containing” should be interpreted as “containing, but not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases at least one and one or more to introduce claim recitations. However, the use of such phrases should not be construed to imply that the introduction of a claim recitation by the indefinite articles “a” or an limits any particular claim containing such introduced claim recitation to embodiments containing only one such recitation, even when the same claim includes the introductory phrases one or more or at least one and indefinite articles such as “a” or an (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

1. A device for capturing video comprising:
a camera configured to record a plurality of images in succession such that the plurality of images displayed in succession creates an appearance of motion;
a wireless communication component configured to transmit one or more of the plurality of images to a server;
one or more processors configured to execute instructions; and
a computer-readable media containing executable instructions that when executed by the one or more processors are configured to cause the device to:
instruct the camera to record the plurality of images;
select a consecutive subset of the plurality of images as a block of images; and
instruct the wireless communication component to transmit the block of images to the server.

2. The device of claim 1, wherein the instructions are further configured to cause the one or more processors to instruct the wireless communication component to transmit the block of images to the server such that the server can stream the block of images to a remote device within about one minute.

3. The device of claim 1, wherein the instructions are further configured to cause the one or more processors to instruct the wireless communication component to transmit the block of images to the server using Hypertext Transfer Protocol (HTTP) Live Streaming (HLS).

4. The device of claim 1, wherein the instructions are further configured to cause the one or more processors to:
select a next consecutive subset of the plurality of images as a second block of images; and
instruct the wireless communication component to transmit the second block of images to the server such that the server can immediately stream the second block of images to a remote device after the remote device has streamed the block of images from the server.

5. The device of claim 1, wherein the instructions are further configured to cause the one or more processors to compress the block of images before transmitting the block of images to the server.

6. The device of claim 5, wherein the instructions are further configured to cause the device to compress the block of images using H.264 or high efficiency video coding (HEVC).

7. The device of claim 1, wherein the instructions are further configured to cause the one or more processors to capture a plurality of resolutions of each of the plurality of images using the camera.

8. (canceled)

9. The device of claim 7, wherein the instructions are further configured to cause the one or more processors to instruct the wireless communication component to simultaneously transmit at least two resolutions of each image of the block of images.

10. The device of claim 7, wherein the instructions are further configured to cause the one or more processors to select one of the plurality of resolutions for the block of images.

11. The device of claim 10, wherein the selection is based on a communication speed or bandwidth capability of a communication channel between the server and the device.

12. The device of claim 10, wherein the instructions are further configured to cause the one or more processors to instruct the wireless communication component to transmit the block of images at a first resolution and transmit a next consecutive subset of the plurality of images as a second block of images at a second resolution.

13. A system comprising:
a server configured to stream video to a remote device; and
a device for capturing video comprising:
a camera configured to record a plurality of images in succession such that the plurality of images displayed in succession creates an appearance of motion;
a wireless communication component configured to transmit one or more of the plurality of images to the server;
one or more processors configured to execute instructions; and
a computer-readable media containing executable instructions that when executed by the one or more processors are configured to cause the device to:
instruct the camera to record the plurality of images;
select a consecutive subset of the plurality of images as a block of images; and
instruct the wireless communication component to transmit the block of images to the server such that the server can stream the block of images within about one minute.

14. The system of claim 13, wherein the server makes the block of images accessible for streaming from the server within about one minute.

15. The system of claim 13, wherein the instructions are further configured to cause the one or more processors to:
select a next consecutive subset of the plurality of images as a second block of images; and
instruct the wireless communication component to transmit the second block of images to the server such that the server can stream the second block of images to the remote device within about one minute.

16. (canceled)

17. The system of claim 13, wherein the instructions are further configured to cause the one or more processors to compress the block of images before transmitting the block of images to the server.

18. (canceled)

19. The system of claim 13, wherein the instructions are further configured to cause the one or more processors to determine whether image processing is performed at the device or at the server.

20. The system of claim 13, wherein the instructions are further configured to cause the one or more processors to capture a plurality of resolutions of each of the plurality of images using the camera.

21. (canceled)

22. The system of claim 20, wherein the block of images comprise lowest resolution images of the plurality of resolutions and the instructions are further configured to cause the one or more processors to instruct the wireless communication component to simultaneously transmit at least two resolutions of each image of the block of images.

23. The system of claim 20, wherein the block of images comprise lowest resolution images of the plurality of resolutions and the instructions are further configured to cause the one or more processors to select one of the plurality of resolutions for the block of images.

24. (canceled)

25. (canceled)

26. (canceled)

27. A method comprising:
recording a plurality of images by a device including a camera;
selecting a consecutive subset of the plurality of images as a block of images by one or more processors of the device;
transmitting the block of images to a server by a communication component of the device; and
making accessible the block of images for streaming from the server within about one minute.

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)
